(19) United States
(12) Patent Application Publication
(10) Pub. No.: US 2008/0257565 A1
(43) Pub. Date: Oct. 23, 2008

(54) Fire alarm system/ using fireproofing material/UL listed

(76) Inventor: Earl Wayne Fowler, Albuquerque, NM (US)

Correspondence Address: Earl Wayne Fowler, 1813 Washington NE, Albuquerque, NM, 87110, US

(21) Appl. No.: 12/148,499

(22) Filed: Apr. 18, 2008

Related U.S. Application Data
(60) Provisional application No. 60/912,640, filed on Apr. 18, 2007.

(51) Int. Cl. G08B 17/00

(52) U.S. Cl. 169/23

(57) ABSTRACT

This alarm system has a constant source of AC/DC power source from an electrical cable fireproofed [see FIG. 1 & 2] to over 5,000 degrees Fahrenheit, coming off of the main AC supply source between the meter and a DC solenoid cutoff switch [see FIG. 4]. This 12 volt solenoid switch is activated when an alarm, fire sensor [see FIG. 3], and/or a manual over ride is activated. The system can be monitored by others through a computer on the premises or other locations. This alarm system installed with a fireproofed “safe room” to be safe or rescued from and with a constant fireproofed AC power source to operate alarms, safety lights, exhaust fans, and any emergency AC/DC requirements allows the fire zone to be safe to enter with water to fight the fire and give a safe period of time from toxic gases for occupants to safely evacuate the premises.

The present invention relates to a fire alarm system//using fireproofing material/UL listed which is made up of the following required elements:
Using fireproofing material [see FIG. 1 & 2] made from powdered pinto beans and formulated with sodium lauryl sulfate and sized in the range of 10 to 30 microns, known as formula #2 [9 parts bean powder, 1 part sodium lauryl sulfate]. Material will flash [auto-ignite] at 972 degrees Fahrenheit. This fireproofing material can then be injected into lengths of AC/DC conduit pipe, containing the AC/DC wiring of various sizes. The sizes of the conduit pipe being fireproofed would have a size range of one-half inch in diameter to any larger size of conduit pipe currently being manufactured. The optimum fireproofing temperature would be attained with the 2 inch size conduit [see FIG. 1 & 2] or larger which would fire proof the electrical wiring to over 5,000 degrees Fahrenheit.
If longer lengths of fireproofed conduit are required, a normal AC/DC electrical wire connector should be used with a dam in each end of the conduit pipe to keep the powdered fireproofing material inside the conduit pipe.
To fireproof the conduit pipe joints, seal the fire proofing material in 4-ply plastic sheeting [see FIG. 5] and wrap it around the AC/DC connector wires that you are fireproofing before connecting the two joints of conduit pipe.
Alarms both outside and inside structure [see FIG. 4] to be protected that are activated from one or more of the sensors wired [fireproofed] to a LED board with alarms that have continuous AC/DC power to alarms and other components of the system from the fireproofed AC/DC electrical cables.
These alarms can be equipped with switches that can be delayed to give occupants time to evacuate structure before other systems [i.e. fire extinguishing systems] are activated.
DC fireproofed cable leading from the DC fireproofed LED board to room or area to be alarmed [see FIG. 4].
DC heat activated sensors from 122 to 180 degrees Fahrenheit for each room or area to be protected [see FIG. 2 & 3].
DC operated emergency lights for evacuation of structure containing alarm system [see FIG. 4].
Fireproofed AC outlet to connect DC components such as computer and LED board [see FIG. 4].
PC software to operate and monitor system.

These elements are related to the invention:
The fireproofing material sealed [see FIG. 5] in 4-ply plastic sheeting, produced in different sizes to accommodate distances between rafters and joyces both ceiling and walls to fireproof structures.
Using fireproofing material to replace other fireproofing or heat dissipating materials that are environmentally unsafe such as but not limited to PCB's in AC electrical transformers.
Using fireproofing material to fireproof complete AC electrical wiring in all structures wired with AC wiring or new construction of residential and commercial structures.
Creating fireproofed barriers and/or fireproofed walls [see FIG. 5] in land, sea and air vehicles with fireproofing material.
Using fireproofing material as a coating on vertical and horizontal planes to fireproof or as a fire retardant.
Using fireproofing powder as a hazard waste absorbent
Using the fireproofing material as a toxicity absorbent in medical waste absorbent pads
Using the fireproofing material as filter media by processing the powdered version through heat and pressure, [extrusion].

When a fire is detected by one or more of the sensors, the 12 volt DC solenoid cutoff switch shuts off power to the main AC panel box, but still allows the fireproofed AC/DC cable(s) to still be “alive”, which turns on alarms, lights, and allows toxic gases to be evacuated by exhaust fans that are turned on in the fire zone. This allows persons in the structure at the time of the fire and fire fighting personnel in the fire zone to be safe from electrocution and inhalation of poisonous gases. By allowing a continuous supply of safe AC power in a fire zone the invention allows the following to happen:
Faster reaction time to the hazard
Safer conditions in the fire zone
Fire suppression can be obtained because of a continuous safe supply AC power
Safer and faster evacuation such as using elevators that have fireproofed AC cable power source
Able to fight a fire at higher floors of structures because of continuous supply of safe AC current.
Save lives by giving uninterrupted AC power sources to life support systems. The invention could be structured different to keep constant supply of AC power to hospitals, command posts, or any structure that needs the constant AC power for emergency medical care.

While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure be thorough, complete and will fully convey the full scope of the invention to those skilled in the art. Indeed, many modifications and other embodiments of the invention pertain, and which are intended to be and are covered by this disclosure, the drawings and the claims.

### FIGURE DESCRIPTIONS

FIG. 1 is an end view of an AC-DC electrical cable fireproofed to over 5,000 degrees;

FIG. 2 is a side view of a fire alarm system with AC & DC fire proofing cable;

FIG. 3 is an overhead view of a heat activated link or sensor;

FIG. 4 is an overview of the fire alarm system; and

FIG. 5 is a side view of structure showing fireproofing material installed vertically and horizontally, and fire flames burning through tile and 4-ply sheeting.

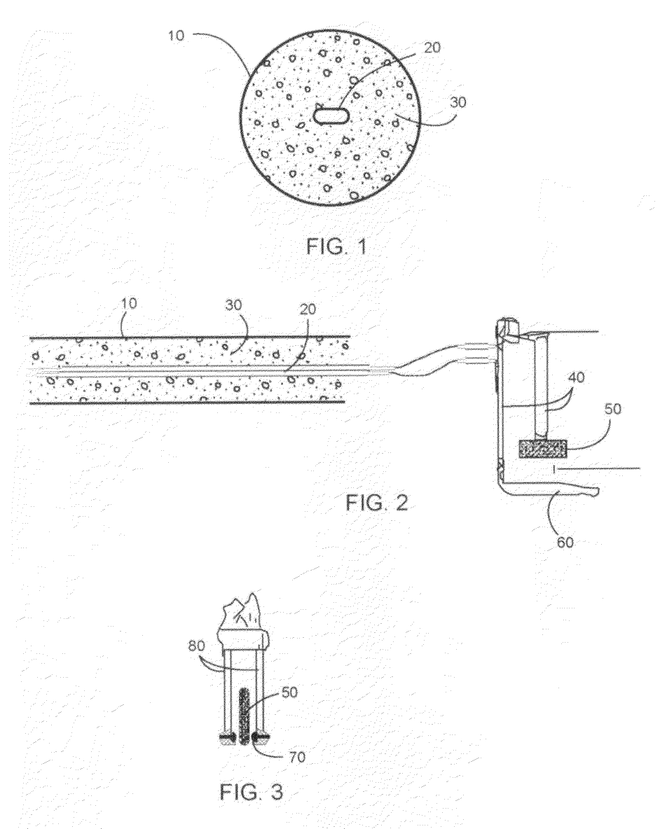

### NUMBER DESCRIPTION LIST

10 is AC or DC electrical from 120 volt to 440 volt (3 to 6 wire),

20 is a 2″ to 8″ electrical conduit pipe.

30 is a trade secret fire proofing material (fireproof cable to over 5,000 degrees).

40 is a metal or plastic bracket for holding solder.

50 is a 120 degree to 190 degree bismuth solder rod.

60 is a plastic pooling cup with DC wires running parallel to each other.

70 is a DC point.

80 is DC wiring.

90 contains fireproofed AC and DC lines.

100 is an LED panel box control center.

110 is an electric meter.

120 are outside and inside alarms.

130 is a fire alarm sensor.

140 is a 12 volt exhaust fan.

150 is a 12 volt safety light.

160 is a manual cut off box (panel).

170 is a 12 volt solenoid cut off switch fire proofed DC cable.

180 is an AC conduit going from meter to outside manual cut off box.

210 is steel “I” beams both vertical and horizontal with fireproofing material secured on all four sides of “I” beams.

220 is 2×4 wood studs placed with 15″ centers.

230 is steel rods and plastic ties to hold fireproofing in place.

240 is fireproofing material in pellet and powder form sealed in 4-ply sheeting 13″ wide.

250 is fire flame burning thru drop ceiling tile and 4-ply sheeting.

260 are fireproofing material doubling as a fire retardant or extinguishing the flame.

270 is fireproofing material falling on fire flame and retarding or extinguishing the flame.

280 is the drop ceiling tile (2′×4′) with steel wire mesh above it to hold the fireproofing material in place until a burn through from below.

What is claimed is:

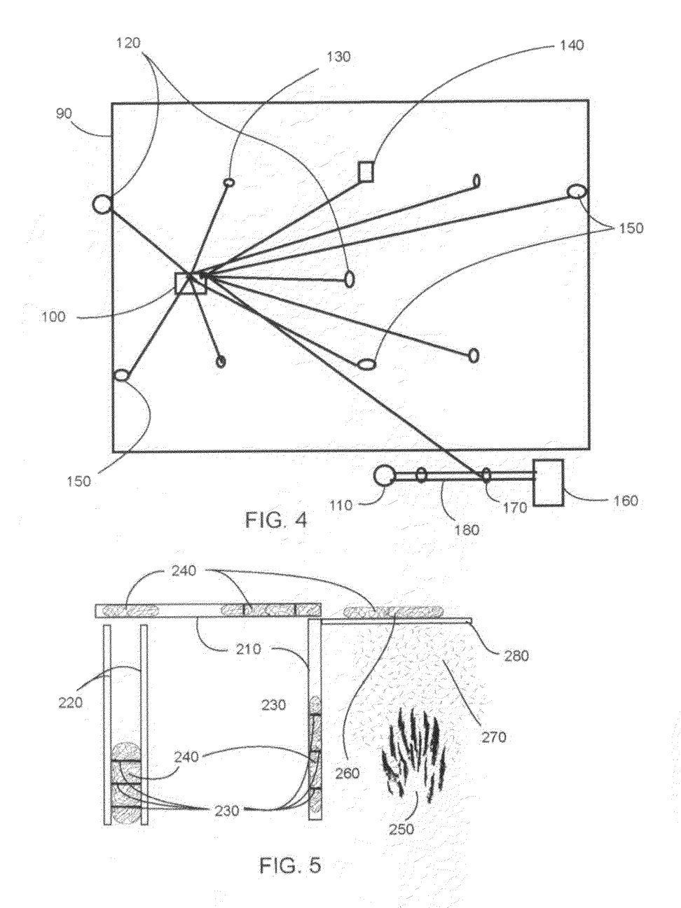

1. An AC/DC electrical fire alarm system comprising of multiple heat activated Sensor stations with fireproofed AC/DC power supply cable [see FIG. 1 & 2] with a DC Solenoid cut-off switch placed between the metered fireproofed power source and the outside main panel box [see FIG. 4] . Fireproofed DC heat sensors are used with heat temperature ranges between 122 and 180 [see FIG. 3]. The DC Solenoid cutoff switch and DC heat sensors receive a continuous supply of AC/DC power from the primary power supply source. The fireproofed AC cable source also provides continuous power to outside and inside alarms activated when a fire in the protected structure activates one or more of the heat sensors. Delayed alarms and other systems such as safety light systems, exhaust fan systems for toxic gases in the fire zone, fire extinguishing systems, LED readout board and all emergency or vital systems required in structure are all powered by a fireproofed AC/DC power cable to a personal computer that is protected by fireproofing material from any structural fire and equipped with copyrighted software to continuously operate all systems of the structure being protected.

2. The system as defined in claim 1 comprising of multiple heat activated sensor stations.

3. The system as defined in claim 1 comprising of AC/DC electrical fireproofed cable to over 5000 degrees Fahrenheit [see FIG. 1].

4. The system as defined in claim 1 comprising of a fireproofed DC cutoff solenoid switch placed between the fireproofed system AC/DC power cable and the AC service panel box [see FIG. 4].

5. The system as defined in claim 1 comprising of heat sensors with heat activated bismuth solder with melt temperature range of 122 to 180 degrees Fahrenheit.

6. The system as defined in claim 1 comprising of outside and inside alarms with wiring fireproofed from electrical cable power source to alarm(s) [see FIG. 4].

7. The system as defined in claim 1 comprising of fireproofed DC cable safety lights/with battery backup that automatically turns on when the main power source panel shuts off.

8. The system as defined in claim 1 comprising of fireproofed filter media made with fireproofed material with heat and pressure used as in extrusion and placed in exhaust fans in each area to be protected.

9. The system as defined in claim 1 comprising of a A/C D/C fireproofed electrical cable that allows fire fighting personnel to fight the fire without being electrocuted from live AC wires in the fire zone.

10. The system as defined in claim 1 comprising of a A/C D/C fireproofed cable that gives continuous supply of power to exhaust fans to evacuate the poisonous gases created in the fire zone allowing fire fighting personnel to fight the fire without being harmed from poisonous gases.

11. The systems as defined in claim 1 comprising of fireproofed AC/DC cable to give continuous supply of power to emergency or required systems in the structure.

12. The fireproofing material as defined in claim 1 comprising of 9 parts pinto bean powder and 1 part sodium lauryl sulfate that is known to the inventor as formula #2 and which is a sized powder from 5 microns to 20 microns. This material can be shaped in various different compounds from liquid to pellets to blocks and used in various different ways. The flash point [ignition temperature is 972 degrees Fahrenheit. The fire proofing material is hydrostatic which makes it's as a heat dissipater and as an absorbent for liquids or solids.

13. The fireproofing material as defined in claim 12 used as an environmentally hazard waste absorbent.

14. The fireproofing material as defined in claim 12 used as an environmentally safe replacement for electrical transformers that use PBC's for cooling.

15. The fireproofing material as defined in claim 12 used as a filter media placed in an exhaust fan to absorb toxic gases from the fire zone.

16. The fireproofing material as defined in claim 12 used as biomedical waste in pad form of various sizes and dimensions.

17. The fireproofing material, as defined in claim 12 to fireproof the electrical conduit pipe joints with 4ply plastic sheeting.

18. The fireproofing material, as defined in claim 12 used as fireproofing to fireproof walls, ceilings, attics and doors.

19. The fireproofing material as defined in claim 12 used as fireproofing of complete AC/DC electrical systems in residential and commercial structures as a reconstruct or new construction.

20. The fireproofing material, as defined in claim 12 used as a protective fire barrier or wall in land, sea or air vehicles.

21. The fireproofing material, as defined in claim 12 used as a coating on a vertical or horizontal plane to fireproof or as a fire retardant.

22. The fireproofing material, as defined in claim 12 that is used as a protective building material [see FIG. 5] or as a fire wall(s) to protect lives and property from oxygenated atmospheres and other environs.

23. The fireproofing material, as defined in claim 12 that is used as a fireproofed mobile wall to extinguish and recap gas and oil well fires.

24. The fireproofing material, as defined in claim 12 that is used to provide a safe supply to single floor AC electrical systems with a safe connect and disconnect to an upper or lower level floor that is engulfed in fire. Firefighters can still fight fire at that level and evacuate occupants above and/or below the fire engulfed floor level.

25. The AC fireproofed cable as defined in claim 24 that is used to supply continuous safe AC power to floors above and below a fire engulfed floor to fight fire and safely evacuate occupants on the floors above and below the level on fire.

26. The AC fireproofed cable as defined in claim 24 that is used to supply continuous safe power to elevators to safely evacuate occupants from high rise buildings during a fire.

27. The AC fireproofed cable as defined in claim 24 that is used to supply continuous safe power to fire extinguishing equipment or systems to extinguish any and all fires in the multiple floored building.

28. The AC fireproofed cable as defined in claim 24 whereas on each floor of a multiple floor building a “safe room” is protected with the fireproofed material.

29. The AC fireproofed cable as defined in claim 24 whereas each “safe room” would be equipped with fireproofed phones cables to communicate with fire and rescue personnel outside of fire zone.

30. The AC fireproofed cable as defined in claim 24 whereas a safe supply of AC power could be provided to each “safe room/with safe air supply” to power emergency lights, filtered refrigerated air, refrigerated emergency rations and water, and fireproofed media filtered exhaust fans.

31. The AC fireproofed cable as defined in claim 24 whereas each floor of multi-floored buildings has an individual emergency safe elevator that is equipped AC fireproofed cable from the original AC power source to each emergency elevator on each floor of the building(s).

32. The fireproofing material as described in claim 12 fireproofing all steel girders both vertical and horizontal in multi-level buildings [see FIG. 5].

33. The fireproofing material as described in claim 12 fireproofing the adjoining wall between the residential area and the garage to exceed building code fire protection [see FIG. 5].

34. The fireproofing material as described in claim 12 in a powdered form secured in 4 ply plastic sheeting and secured in the ceiling with steel mesh where upon a fire below it burns through the drop ceiling and burns the 4 ply plastic sheeting allowing the powder to fall to the floor caused by the pull of gravity extinguishing or retarding the fire [see FIG. 5].
